(19) United States
(12) Patent Application Publication
(10) Pub. No.: US 2013/0334132 A1
(43) Pub. Date: Dec. 19, 2013

(54) Methods for Treatment of Waste Activated Sludge

(71) Applicants: Jason M. Calhoun, Riner, VA (US); Paul W. Skillicorn, Snow Hill, NC (US)

(72) Inventors: Jason M. Calhoun, Riner, VA (US); Paul W. Skillicorn, Snow Hill, NC (US)

(21) Appl. No.: 13/967,241

(22) Filed: Aug. 14, 2013

Related U.S. Application Data
(63) Continuation-in-part of application No. 12/775,861, filed on May 7, 2010, now abandoned.

(51) Int. Cl. C02F 3/32

(52) U.S. Cl. CPC C02F 3/327
USPC 210/602

(57) ABSTRACT

A process for treating wastewater with powdered lignocellulosic particles in low dissolved oxygen conditions to simultaneously achieve nitrification and denitrification.

### CROSS-REFERENCE TO RELATED APPLICATIONS

This application is a continuation-in-part of application Ser. No. 12/775,861, filed May 7, 2010, which is incorporated herein by reference in its entirety.

### BACKGROUND OF THE INVENTION

1. Field of the Invention

The present invention relates to the treatment of wastewater, such as, for example, municipal, industrial or concentrated animal feeding operation (CAFO) wastewaters.

2. Description of the Prior Art

While traveling through sewer pipes, the majority of nitrogen contained in raw sewage (urea and fecal material) is converted from organic-nitrogen to ammonia and ammonium (hereinafter “ammonia”) through a process called hydrolysis. Further, many commercial enterprises may use cleaning or industrial products containing ammonia, which may end up in the wastewater system. Removal of ammonia from the waste water stream is necessary because high and toxic levels of ammonia (and nitrates) upset the balance of water's chemistry, causing unwanted bacteria and other microorganisms to grow, exposing aquatic occupants to many diseases, and permitting algal blooms to dominate the environment.

Removal of ammonia and other nitrogen compounds from wastewater has typically involved two separate and distinct processes: nitrification and denitrification. Nitrification is the biological oxidation of ammonia into nitrite, followed by the oxidation of these nitrites into nitrates. Denitrification is another biological process which, in the relative absence of oxygen, converts the nitrates into nitrogen gas (N2), which can safely be released into the atmosphere. In some wastewater treatment plants, small amounts of methanol, ethanol, acetate, glycerin, or proprietary products are added to the wastewater to provide a carbon source for the denitrification bacteria. The cost of this process resides mainly in aeration (bringing oxygen in the reactor) and the addition of an external carbon source (e.g., methanol) for the denitrification.

Nitrification is the biological oxidation of ammonia with oxygen into nitrate by first converting ammonium ions into nitrites, then converting the nitrites into nitrates. Within a wastewater treatment plant, the first step (oxidation of ammonia into nitrite) has traditionally been performed by ammonia-oxidizing bacteria belonging to the genera Nitrosomonas and Nitrosococcus, whereas the second step (oxidation of nitrite into nitrate) has been carried out primarily by bacteria of the genus Nitrobacter. The entire nitrification process requires oxygen, and typically a wasterwater treatment plant must aerate the wastewater stream with dissolved oxygen to obtain desirable results. Both of these species are considered autotrophic bacteria because they use carbon dioxide (CO2) as the source of carbon for building cell tissue. Nitrosomonas and Nitrobacter can be labeled as “nitrifiers,” and are strict “aerobes,” meaning they must have free dissolved oxygen to perform their work. Nitrification occurs only under aerobic conditions at dissolved oxygen levels of 1.0 ppm or more. At dissolved oxygen (DO) concentrations less than 0.5 ppm, the growth rate is minimal.

Denitrification occurs when oxygen levels are depleted and nitrate becomes the primary oxygen source for microorganisms. The process is performed under anoxic conditions, when the dissolved oxygen concentration is preferably less than 0.5 ppm, ideally less than 0.2. When bacteria break apart nitrate (NO3—) to gain the oxygen (O2), the nitrate is reduced to nitrous oxide (N2O), and, in turn, nitrogen gas (N2). Since nitrogen gas has low water solubility, it escapes into the atmosphere as gas bubbles. Nitrate can be transformed to nitrogen gas under anoxic conditions by facultative heterotrophic bacteria, which uses organic carbon for building cell tissue and get their oxygen by taking dissolved oxygen out of the water or by taking it off of nitrate molecules. If dissolved oxygen is present, the organisms will use it rather than the nitrate bound oxygen in their metabolism. In this latter case, nitrogen in the form of nitrates would remain to pass into and through the soil, eventually ending up in groundwater. Denitrification occurs when oxygen levels are depleted and nitrate becomes the primary oxygen source for microorganisms.

Both steps are producing energy to be coupled to ATP synthesis. Nitrification requires a long retention time, a low food to microorganism ratio (F:M), a high mean cell residence time (measured as MCRT or Sludge Age), and adequate buffering (alkalinity). A plug-flow, extended aeration tank is ideal. Temperature, as discussed below, is also important, but not necessarily critical. The two-step reaction is usually very rapid. Because of this it is rare to find nitrite levels higher than 1.0 ppm in water. The nitrate formed by nitrification is, in the nitrogen cycle, used by plants as a nitrogen source (synthesis) or reduced to N2 gas through the process of denitrification.

In the prior art, wastewater cannot be denitrified until the nitrification process has been completed—the treatment processes for nitrogen removal are then generally premised on what is termed “sequential nitrification/denitrification.” This process, when well-tuned, optimizes the natural biological processes using engineered systems. Although there are other possible processes, sequential biological nitrification/denitrification is the only process that has been demonstrated to be economically and technically feasible for wastewater nitrogen removal. The first step in the sequence uses aerobic processes to transform the organic nitrogen and ammonia products in the septic tank effluent to nitrate. This is the nitrification step mentioned earlier in the discussion. A variety of treatment devices can be used to accomplish this aerobic process, such as sand or gravel filters or aerobic treatment units. For example, when septic tank effluent is applied at a low organic loading rate to deep, well aerated media, such as a two-foot deep, single pass sand filter, nitrification has been effectively accomplished. During this process, carbonaceous biochemical oxygen demand (CBOD) is also removed.

The second step requires shifting the process from an aerobic environment to an environment without dissolved oxygen (referred to as an anoxic process) where different species of bacteria can grow. These bacteria utilize the nitrate-bound oxygen formed in the first step to oxidize organic matter and in the process transform the nitrogen to gas. These bacteria also need organic carbon during the process in order to form new cell tissue. Inadequate supplies of organic carbon will limit the denitrification process. A carbon source must be provided for denitrification to occur.

Thus, traditional processes for the removal of nitrogen compounds from wastewater requires for the nitrification and denitrification steps to occur separately and sequentially: an aerobic nitrification step followed by an anoxic denitrification step to reduce the CBOD. Furthermore, the traditional process requires the introduction of a carbon source during the second step to facilitate the denitrification.

U.S. Pat. No. 7,481,934 is incorporated herein by reference in its entirety, and included as prior art background, along with all patents and documents cited during prosecution, namely U.S. Pat. Nos. 7,157,000, 6,461,510, 5,302,288, 5,192,442, 5,068,036, 4,919,815, 4,897,196, 4,810,386, 4,292,176, 4,073,722, 4,069,148, 3,957,632, and 3,904,518; and U.S. Patent Application Publication Nos. 20020249451 and 20020148780.

### SUMMARY OF THE INVENTION

The present invention relates to the treatment of wastewater or any other form of waste having nitrogen compounds disposed of in a liquefied form wherein water comprises the overwhelming portion of said liquid carrier. The systems and methods of the present invention address the longstanding, unmet need for efficient and low cost removal of nitrogen compounds from wastewater. Treatment, notably reduction in the nitrogen compounds, is effected by bacterial treatment under low dissolved oxygen conditions, augmented by finely powdered natural lignocellulosic material.

It is an object of this invention to provide an improved wastewater treatment process that is generally applicable to treatment of nitrogen compound-containing municipal, industrial and CAFO waste streams at a digester stage through the supplementary use of powdered kenaf core (PKC) and other finely powdered natural lignocellulosic materials (PNLM) under low dissolved oxygen (DO) conditions.

Another object of the present invention is to allow for the nitrification and denitrafication processes to occur simultaneously by regulating the amount of lignocellulosic materials used and the amount of dissolved oxygen applied, thereby significant time and cutting costs by reducing the amount of resources needed.

These and other aspects of the present invention will become apparent to those skilled in the art after a reading of the following description of the preferred embodiments when considered with the drawings, as they support the claimed invention.

### BRIEF DESCRIPTION OF THE DRAWINGS

FIG. 1 is a schematic flow diagram of one embodiment of the invention in which wastewater is treated via a method according to the present invention.

### DETAILED DESCRIPTION

Referring now to the drawings in general, the illustrations are for the purpose of describing a preferred embodiment of the invention and are not intended to limit the invention thereto.

The present invention provides an improved process for treating wastewater having a significant nitrogen content in which powdered natural lignocellulosic material (PNLM), especially powdered kenaf core (PKC), is added to the wastewater, preferably, in, at or proximal to the first digestion stage of the process while initially maintaining the dissolved oxygen between about 0.5 ppm and about 1.5 ppm. Thus, in the present invention the dissolved oxygen is kept at a level that heretofore would not favor denitrification. Surprisingly, it was discovered that maintaining the dissolved oxygen in this range with powdered kenaf permitted both nitrification and denitrification to occur simultaneously.

The preferred kenaf core material has a specific surface area greater than about 200 square meters per gram, more preferably greater than about 400 square meters per gram, and still more preferably greater than about 500 square meters per gram. Commonly, such kenaf core is in powdered form and has a particle size such that at least 50 percent of it will pass through 100 mesh per inch sieve, although generally about 70 to about 99 percent will pass through such a sieve. The present invention aids in treatment by improving system efficiencies and lowering costs.

Thus, a method for treating waste in a waste digestion process according to the present invention includes the method steps of:
(1) monitoring influent flow, ammonia concentration, and sludge retention time (SRT);
(2) mixing kenaf with the influent according to calculation: influent flow rate x ammonia (ppm)×32×8.34/SRT;
(3) monitoring the dissolved oxygen concentration and maintaining the dissolved oxygen concentration between about 0.2 ppm to 3.5 ppm, more preferably between about 0.5 ppm and about 1.5 ppm, even more preferably about 1.5 ppm;
(4) when the biological health of the is improving as measured by the volatile suspended solids (VSS) and mixed liquor suspended solids (MLSS) concentrations increasing 10-15% and the dissolved oxygen uptake rate (DOUR) increases to >90%, then lowering the DO to between about 0.2 ppm and about 0.8 ppm; more preferably about 0.5 ppm; and
(5) digesting the wastestream and particle mixture until the nitrogen compound levels are acceptable; and optionally
(6) upon achievement of the desired nitrogen levels, raising the dissolved oxygen content to accelerate the CBOD reduction; and optionally
(7) adding a kenaf maintenance dosage to the reactor dependent upon wasting rate: wasting flow rate×32×8.34/SRT.

The present invention thereby reduces the steps required for treatment of wastewater. Furthermore, the present method reduces the retention time and also the energy usage and equipment costs incurred for the aeration required under the prior art methods. Further benefits of the process include: increased sludge retention time, low dissolved oxygen nitrification, increased settling, concentrated biomass, increased BOD removal, lower carbon demand for nitrification, increased phosphorus removal, and more efficient denitrification.

In this process, the combined cellulose and hemicelluloses content of the particle is preferably greater than about 30%. More preferably, the cellulose content of the particle is greater than about 60%. The lignocellulosic particle is preferably added at a rate of between about 5% and about 40% of total solids. The lignocellulosic particle preferably has a specific surface area greater than about 100 square meters per gram; more preferably, greater than about 200 square meters per gram; even more preferably greater than about 400 square meters per gram; even more preferably greater than about 500 square meters per gram. Preferably, the particle size is about 100 mesh.

The lignocellulosic particle is preferably a powdered natural lignocellulosic material and can consist of sphagnum moss, hemp hurd, jute stick, balsa wood, other hard and soft woods, kenaf core, crop straws, grass specie stems, bamboo specie stems, reed stalks, peanut shells, coconut husks, pecan shells, other shells, rice husk, other grain husks, corn stover, other grain stalks, cotton stalk, sugar cane bagasse, conifer and hardwood barks, corn cobs, and combinations thereof.

### First Preferred Embodiment

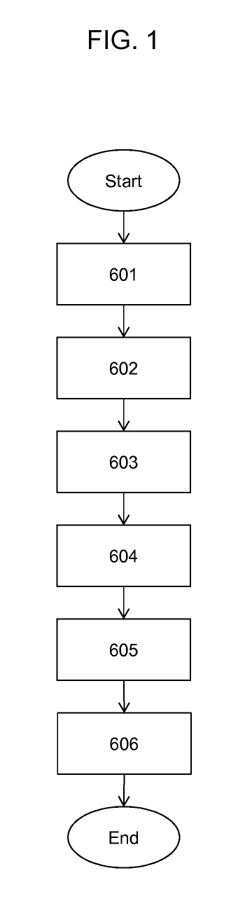

Referring to FIG. 1, this describes the process in a fixed film activated sludge system where the fixed film biomass works to remove both nitrogen compounds and CBOD and the anoxic system works to denitrify. The addition of the fixed film bio-media allows for increased biomass to improve carbon removal and to allow for low DO nitrifying organisms to flourish, achieving nitrification and low DO levels. The fixed film process also uses far less carbon to nitrify since the DO levels are kept at a lower concentration.

In this type reactor, the present invention includes the following steps:

Step 601: monitoring the influent flow, ammonia and SRT;

Step 602: mixing kenaf with the influent according to calculation: Flow×Ammonia (ppm)×32×8.34/SRT;

Step 603: monitoring the dissolved oxygen and maintaining the dissolved oxygen of the mixture at about 1.5 ppm;

Step 604: monitoring the VSS, MLSS and DOUR and lowering the DO to about 0.5 ppm when the VSS and MLS increase by 10-15% and DOUR increases to >90%;

Step 605: digesting the wastestream and particle mixture until the nitrogen levels are reduced to an acceptable level;

Step 606: once the desired nitrogen levels are reached, the oxygen level is raised to allow aerobic bacteria to consume the remaining CBOD.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A method for treating wastewater, comprising:
receiving wastewater into a waste digester;
monitoring the influent flow, ammonia and sludge retention time;
mixing kenaf with the influent according to the calculation: flow×ammonia (ppm)×32 ×8.34/SRT;
maintaining the dissolved oxygen of the mixture between about 0.2 and 3.5 ppm in a first phase; and
monitoring the VSS, MLSS and DOUR and lowering the DO to between about 0.2 and about 0.8 ppm in a second phase when the VSS and MLS increase by between about 10 and about 15% and the DOUR increases to greater than about 90%;
thereby treating the wastewater at a lower carbon demand for nitrification.

2. The method of claim 1, wherein the dissolved oxygen is maintained between about 0.5 ppm and about 1.5 ppm in the first phase.

3. The method of claim 1, wherein the dissolved oxygen is maintained at about 1.5 ppm in the first phase.

4. The method of claim 1, wherein the dissolved oxygen is maintained at about 0.5 ppm in the second phase.

5. The method of claim 1, further including the step of monitoring the nitrogen levels and raising the DO when nitrogen levels reach an acceptable level.

6. A method for reducing nitrogen in aqueous solutions, comprising:
monitoring and calculating properties of the solution, including the flow rate of the solution entering a vessel, the ammonia concentration of the solution, the dissolved oxygen concentration of the solution, and the sludge retention time (SRT);
mixing lignocellulosic materials with the solution to create a mixed solution according to the lignocellulosic weight formula: (the solution flow rate)×(the ammonia concentration)×32×8.34/SRT;
measuring a first volatile suspended solid concentration of the mixed solution and a first mixed liquor suspended solid concentration of the mixed solution;
maintaining the dissolved oxygen concentration between 0.2 ppm and 3.5 ppm;
monitoring the volatile suspended solid concentration, the mixed liquor suspended solid concentration, and the dissolved oxygen uptake rate (DOUR);
maintaining the dissolved oxygen concentration between 0.2 ppm and 0.8 ppm if:
the volatile suspended solid concentration and the mixed liquor suspended solid concentration both increase at least 10% from the first volatile suspended solid concentration measurement and the first mixed liquor suspended solid concentration measurement; and
the DOUR measurement is at least 90%;
thereby treating the solution at a lower carbon demand for nitrification.
